(19) United States
(12) Patent Application Publication
(10) Pub. No.: US 2025/0110368 A1
(43) Pub. Date: Apr. 3, 2025

(54) LIQUID CRYSTAL DISPLAY DEVICE

(71) Applicant: Japan Display Inc., Tokyo (JP)

(72) Inventors: Masafumi OKADA, Tokyo (JP); Ken KAGABU, Tokyo (JP)

(73) Assignee: Japan Display Inc., Tokyo (JP)

(21) Appl. No.: 18/894,013

(22) Filed: Sep. 24, 2024

(30) Foreign Application Priority Data
Oct. 2, 2023 (JP) 2023-171177

(51) Int. Cl. G02F 1/13357; F21V 8/00; G02F 1/1333; G02F 1/1343; G02F 1/1368

(52) U.S. Cl. CPC G02F 1/1336; G02B 6/0053; G02B 6/0068; G02B 6/0073; G02F 1/133331; G02F 1/134309; G02F 1/1368

(57) ABSTRACT

The invention relates to a transparent liquid crystal display device. The configuration is as follows. A display area is formed in a portion where a TFT substrate and an opposing substrate overlap, a terminal area is formed in a portion of the TFT substrate that does not overlap with the opposing substrate, and a cover glass is arranged over the TFT substrate or the opposing substrate; a first side surface of a light guide plate contacts the terminal side of the cover glass, a second side surface of the light guide plate, which is opposite to the first side surface, is arranged with a plurality of LEDs, a first lens is formed on the first side surface, and a round prism is formed on the second side surface. A pitch of round prisms in a first direction is larger than a width of the round prism in the first direction.

### CROSS-REFERENCE TO RELATED APPLICATION

The present application claims priority from Japanese Patent Application JP 2023-171177 filed on Oct. 2, 2023, the content of which is hereby incorporated by reference into this application.

### BACKGROUND OF THE INVENTION

### (1) Field of the Invention

This invention relates to a display device, and in particular, to a transparent display device using a liquid crystal display.

### (2) Background Technology

There is a demand for transparent displays with a visible background like a glass. In the transparent displays, when images are displayed, the same screen can be displayed on the front side and the back side. In areas where no image is displayed, the background image can be seen through the glass, and when displaying an image, the image can be superimposed on the background. Such a transparent display can be realized, for example, using a liquid crystal display device.

Patent Document 1 describes an example of a transparent display using a liquid crystal display device. Patent document 2 describes a light source device in which light from multiple light sources is homogenized using a prism sheet in which fine prisms are arranged on the incoming and outgoing sides.

### PRIOR ART DOCUMENT

### Patent Documents

[Patent Document 1] Japanese Patent Publication No. 2019-219440

[Patent Document 2] Japanese Patent Publication No. 2019-200358

### SUMMARY OF THE INVENTION

Transparent liquid crystal display (LCD) devices cannot use a direct backlight. Therefore, the light source is a sidelight type light source, in which the light source is placed on the side of the substrate. From this sidelight, uniform light must be efficiently supplied to the transparent liquid crystal display panel. The actual light source uses light emitting diodes (LEDs), which may be white LEDS or LEDs emitting separate R (red), G (green) and B (blue) light in parallel.

The task of the present invention is to improve the light utilization efficiency in transparent liquid crystal displays and to provide uniform light to the display area, thereby realizing a transparent display device with a bright, small color variation and an image with excellent contrast.

The present invention overcomes the above-mentioned problems, and typical means are as follows.
(1) A liquid crystal display device having a liquid crystal being sandwiched between a thin-film transistor substrate including a pixel electrode and an opposing substrate, in which a display area is formed in a portion where the thin-film transistor substrate and the opposing substrate overlap, and a terminal area is formed in a portion of the thin-film transistor substrate that does not overlap with the opposing substrate, a cover glass is arranged over the thin-film transistor substrate or the opposing substrate; a first side surface of a light guide plate contacts the terminal area side of the cover glass, a second side surface of the light guide plate, the second side surface being opposite to the first side surface of the light guide plate, is arranged with a plurality of light emitting diodes; first lenses are formed on the first side surface of the light guide plate, round prisms are formed on the second side surface of the light guide plate, a pitch of the round prisms in a first direction is larger than a width in the first direction of a round prism.
(2) The liquid crystal display device according to (1), in which the width in the first direction of the round prism is 80% to 95% of the pitch in the first direction of the round prism.
(3) The liquid crystal display device according to (1), in which a radius of curvature at an apex of the round prism is 0.01 mm or more, and a straight line exists at an oblique line in the round prism.
(4) The liquid crystal display device according to (1), in which a surface of a first lens is a rough surface.
(5) The liquid crystal display device according to (1), in which Rz of the rough surface is 1.0 micrometer or more, and Sm of the rough surface is 0.5 micrometer or more. In the meantime, Rz and Sm are defined in JIS (Japanese Industrial Standard).
(6) The liquid crystal display device according to (1), in which Rz/Sm is 2 or more.
(7) The liquid crystal display device according to (1), in which a displayed image can be seen both from a side of the thin-film transistor substrate and from a side of the opposing substrate.

### BRIEF DESCRIPTION OF THE DRAWINGS

FIG. 1 is a front view of a transparent liquid crystal display device;

FIG. 2 is a side view of the transparent liquid crystal display device;

FIG. 3 is a cross-sectional view depicting the operation of a transparent liquid crystal display panel;

FIG. 4 is a cross-sectional view depicting details of a liquid crystal layer;

FIG. 5 is a plan view of a transparent liquid crystal display device of Embodiment 1;

FIG. 6 is a cross-sectional view of A-A of FIG. 5;

FIG. 7 is a cross-sectional view of a light guide plate;

FIG. 8 is a cross-sectional view depicting the action of a round prism on an incident surface of the light guide plate;

FIG. 9 is a cross-sectional view depicting examples of the dimensions of a lens formed on the light guide plate;

FIG. 10 is a cross-sectional view depicting a rough surface formed on a lenticular lens formed on an exit surface of the light guide plate;

FIG. 11 is an example of a rough surface;

FIG. 12 is a plan view of a liquid crystal display panel in which luminance distribution is measured; and

FIG. 13 is a graph depicting the luminance distribution of the liquid crystal display panel in the configuration of Embodiment 2.

### DETAILED DESCRIPTION OF THE PREFERRED EMBODIMENT

The following Embodiments are used to explain the invention in detail.

### Embodiment 1

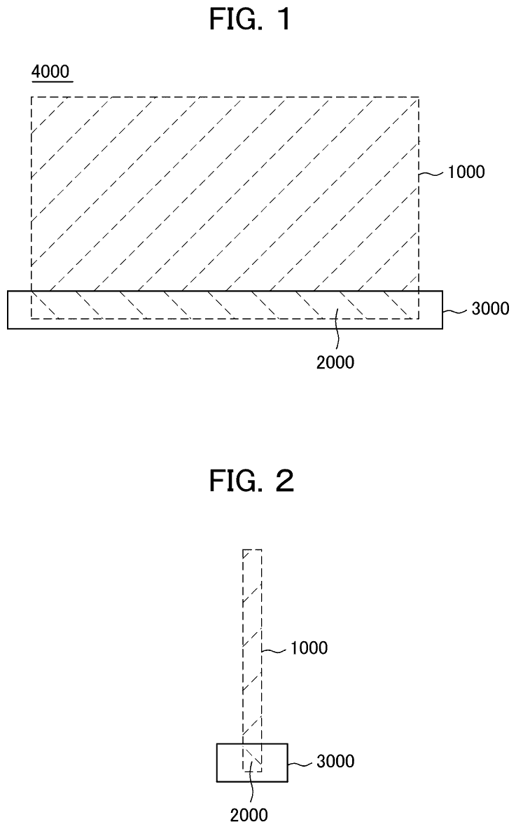

FIG. 1 depicts a front view of a transparent liquid crystal display device 4000 and FIG. 2 depicts a side view. In FIGS. 1 and 2, there is no backlight on the back of a display area 1000 and the substrate is made of transparent glass, so that light is normally transmitted and the back of the transparent liquid crystal display device 4000 can be seen.

A drive unit 2000, which includes a light source as a side light and a drive circuit area, is located in a lower housing 3000. The image displayed on the display area 1000 of a display panel can be viewed from either the back or the front side. The images displayed on the transparent liquid crystal display device can give the impression of floating in the background.

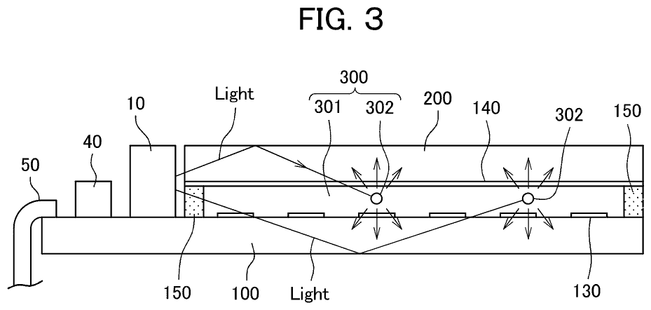

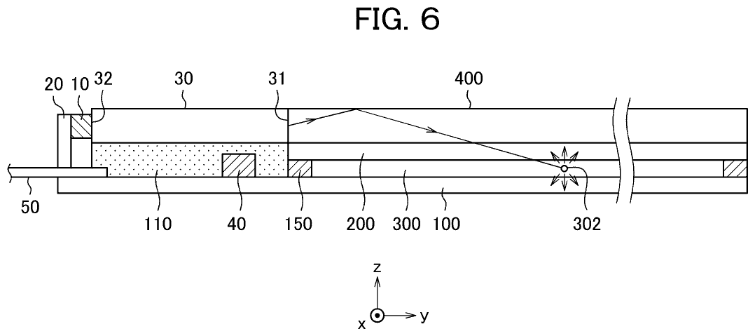

FIG. 3 depicts a cross-sectional view of the operation of the transparent liquid crystal display device 4000. FIG. 3 depicts the basic structure of the transparent liquid crystal display device, which differs slightly from the configuration depicted in FIG. 6 and other examples. In FIG. 3, a liquid crystal 300 is sandwiched between a TFT substrate 100 on which pixel electrodes 130, signal lines, thin-film transistors (TFTs), etc. are formed and an opposing substrate 200 on which common electrodes 14 are formed. As the transparent liquid crystal display device depicted in FIG. 3 is driven by what is called a field sequential system, there is no color filter; a display area is formed in the area where the TFT substrate 100 and the opposing substrate 200 overlap, and a terminal area is formed in the area of the TFT substrate 100 that does not overlap with the opposing substrate 200. The terminal area is formed in the portion of the TFT substrate 100 that does not overlap with the opposing substrate 200.

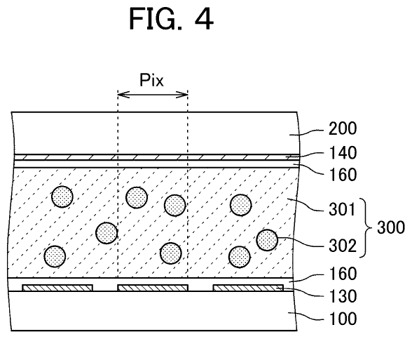

In FIG. 3, the TFT substrate 100 and the opposing substrate 200 are bonded with a sealing material 150 and the liquid crystal 300 is sealed thereinside. The sealing material 150 is formed of transparent resin. The liquid crystal 300 in FIG. 3 is what is called a polymer dispersion liquid crystal, and the structure of which is depicted in FIG. 4. FIG. 4 is an enlarged cross-sectional view of a liquid crystal portion of FIG. 3. In FIG. 4, the liquid crystal 300 is sandwiched between the TFT substrate 100 on which the pixel electrode 130 and an alignment film 160 are formed thereon and the opposing substrate 200 on which a common electrode 140 and the alignment film 160 are formed thereon. In FIG. 4, a pixel Pix is formed corresponding to the pixel electrode 130.

The liquid crystal 300 is called a polymer dispersion liquid crystal and includes a bulk 301 formed by a polymer and fine particles 302 containing liquid crystal molecules. When voltage is applied between the pixel electrode 130 and the common electrode 140, the fine particles 302 containing the liquid crystal molecules rotate and scatter light due to the electric field. If no voltage is applied between the pixel electrode 130 and the common electrode 140, no light is scattered. Since the scattering of light is controlled on a pixel-by-pixel basis, an image is formed. This image can then be seen from both the surface and the rear of an LCD panel.

Returning to FIG. 3, the TFT substrate 100 is formed larger than the opposing substrate 200, and the area where the TFT substrate 100 and the opposing substrate 200 do not overlap is the terminal area. In the terminal area, an LED 10, which is a light source, is arranged opposite the side of the opposing substrate 200, and light from the LED 10 enters the interior of the liquid crystal display panel through the side of the opposing substrate 200 or the sealing material 150. The incident light repeatedly undergoes total reflection and collides with fine particles 302 containing liquid crystal molecules in the liquid crystal layer 300.

When the light collides with the fine particles 302 in the pixel where voltage is applied between the pixel electrode 130 and the common electrode 140, it is scattered as depicted in FIG. 3. On the other hand, in pixels where no voltage is applied between the pixel electrode 130 and the common electrode 140, the light travels straight ahead. As a result, the light incident within the liquid crystal 300 is controlled to scatter in each pixel, thus forming an image.

In FIG. 3, a driver integrated circuit (driver IC) 40 is arranged alongside the LED 10, which is the light source. The driver IC 40 drives the liquid crystal display panel and is subject to high heat during operation. In particular, as the liquid crystal display in FIG. 3 is driven in field sequential mode, data processing is carried out at three times the speed of the normal driving method, so that the driver IC 40 also generates a lot of heat.

A flexible wiring substrate 50 is connected to the edge of the TFT substrate 100 to supply signals and power to the driver IC 40. In the actual display device, there is a wiring substrate for the LEDs to supply power to the LED 10, which is the light source, but this is omitted in FIG. 3.

The issues of the transparent liquid crystal display device with the configuration depicted in FIG. 3 are as follows. That is, light from the LEDs cannot be sufficiently taken into the liquid crystal display panel due to the difficulty of making the thickness of the opposing substrates 200 sufficiently large. In addition, when viewed in a flat plane, a plurality of LEDs 10 are arranged on the sides of the opposing substrate 200, but the difference in luminance between the portions corresponding to the LEDs 10 and those not corresponding to the LEDs 10 becomes large, making it difficult to create a uniform light source. In addition, in a configuration in which single-colored LEDs 10 are arranged in parallel, it is easy for color irregularities to occur.

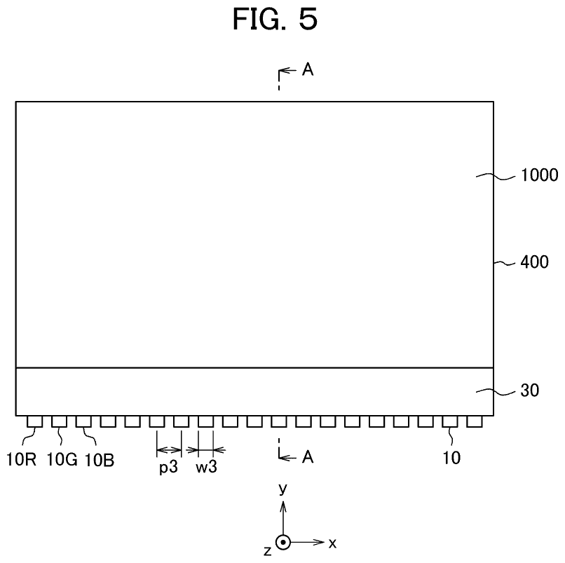

The configuration of the present invention depicted in FIG. 5 can efficiently take in the light from the light source and supply the uniform light to the liquid crystal display panel. FIG. 5 depicts a plan view of a transparent liquid crystal display device 4000 according to Embodiment 1. In FIG. 5, the transparent liquid crystal display device 4000 includes a cover glass 400 including the display area 1000, a light guide plate 30 and a side light including the plurality of LEDs 10. The plurality of LEDs 10 are arranged on an LED substrate 20 and mounted on the side of the light guide plate 30, but in FIG. 5, the LED substrate 20 is omitted for clarity. In FIG. 5, the light guide plate 30 may be made of transparent resin, such as acrylic or polycarbonate, or glass, for example.

In FIG. 5, 10R stands for a red LED, 10G for a green LED and 10B for a blue LED. Red, green and blue light mix in the light guide plate 30 and white light is supplied to the LCD panel. In FIG. 5, the LED 10 is located on the incident side of the light guide plate 30. Instead of the single-color LED 10, a white LED 10 may be used. An outgoing side 31 of the light guide plate 30 is butted against the side of the cover glass 400 of the LCD panel. As will be explained later, in order to improve the utilization efficiency of the light from the LED 10 and to obtain the uniform light, microlenses or microprisms or the like are formed on the incoming and outgoing sides of the light guide plate 30.

FIG. 6 depicts an A-A cross-sectional view of FIG. 5. In FIG. 6, the right side constitutes the display area of the liquid crystal display panel and the left side constitutes the terminal area and side light of the liquid crystal display panel. In FIG. 5, the TFT substrate 100 on which the pixel electrodes, the scanning lines, the video signal lines, TFTs and the like are formed, and the opposing substrate 200 on which the common electrodes and the like are formed are bonded by the sealing material 150, and the liquid crystal layer 300 is sealed thereinside. The sealing material 150 is a transparent sealing material.

The cover glass 400 is arranged over the opposing substrate 200 to supply the light from the sidelight to the display area. The cover glass 400 is thickly formed to facilitate the capturing of the light from the LED 10. The thickness of the cover glass 400 is, for example, approximately 3 mm, as both the TFT substrate 100 and the opposing substrate 200 are, for example, 0.5 or 0.7 mm thick, the cover glass 400 also serves to reinforce a mechanical strength of the LCD display panel.

In FIG. 6, the area where the TFT substrate 100 and the opposing substrate 200 overlap is the display area; the TFT substrate 100 is formed larger than the opposing substrate 200; the area where the TFT substrate 100 does not overlap with the opposing substrate 200 is the terminal area. In the terminal area, the driver IC 40 is arranged to drive the liquid crystal display panel. The flexible wiring substrate 50 is connected to the edge of the terminal area to supply power and signals to the liquid crystal display panel.

On the other hand, a side surface of the light guide plate 30 is butt-glued to the side surface of the edge of the cover glass 400. Optical clear resin (OCR) is used to bond the side surface of the cover glass 400 to the side surface of the light guide plate 30. In FIG. 6, the LEDs 10 are arranged on the other side of the light guide plate 30; the LEDs 10 are arranged in a number on the side of the light guide plate 30, as depicted in FIG. 5. The light guide plate 30 homogenizes the light from the plurality of LEDs 10 and provides a predetermined directivity to the light so that more light is captured by the cover glass 400.

In FIG. 6, the space formed by the light guide plate 30 and the terminal area of the TFT substrate 100 is filled with a resin 110 to maintain a mechanical strength of the transparent LCD device. For example, resin such as silicone resin, urethane resin or acrylic resin can be used as the resin 110.

A thickness of the light guide plate 30 is 3 mm, the same thickness as the cover glass 400. A height of the LED 10 attached to the incident surface of the light guide plate 30 is, for example, 2 mm, which is slightly smaller than the thickness of the light guide plate 30. This is in consideration of the mounting margin. The plurality of LEDs 10 are connected to the LED substrate 20, which is connected to the flexible circuit board 50 or another flexible circuit board to receive the current supply.

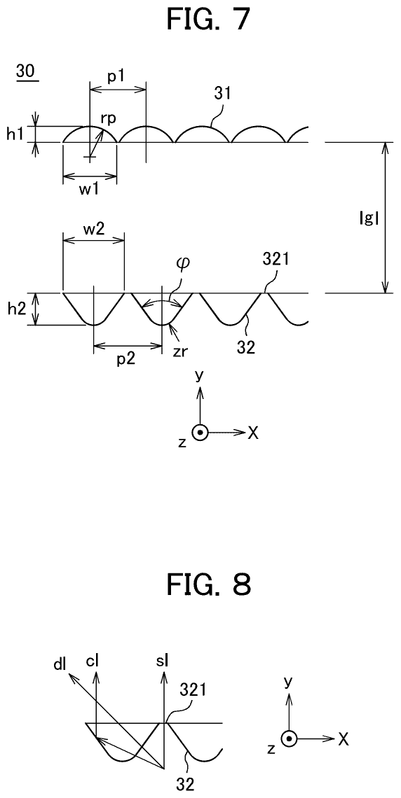

In FIG. 6, the surface of the light guide plate 30 facing the cover glass 400 is referred to as the emitting surface and the surface facing the LED 10 is referred to as the incident surface. As depicted in FIG. 7, a number of round prisms 32 with rounded tips are formed on the incident surface and a number of lenticular lenses 31 are formed on the output surface. The purpose is to ensure that the light from the LED 10 is sufficiently mixed in the light guide plate 30 and that the diffuse light and the straight light are included in a well-balanced manner so that the light is fully taken into the liquid crystal display panel.

In FIG. 7, the lenticular lenses 31 are formed without gaps on the output side of the light guide plate 30. The pitch of the lenticular lenses 31 is p1, the width of the lens is w1, the height of the lens is h1 and the radius of curvature of the cross-section is rp. By the way, the lenticular lens 31 being formed without gaps means that the pitch p1 of the lenses and the width w1 of the lens are identical, but in practice, the pitch p1 of the lenses is slightly larger than the width w1 of the lens due to manufacturing process requirements. In other words, the light guide plate 30 is formed by injection molding resin, and in this manufacturing process, the pitch p1 is slightly larger than the width w1 of the lens.

On the incident surface side of the light guide plate 30, a round prism 32 is formed with a gap. The pitch of the round prisms 32 is p2 and the width is w2, where p2>w2; consequently p2−w2 is the width of the flat surface 321. The height of the round prism is h2 and the radius of curvature of the tip is zr. The apex angle of the round prism is Q.

The length of the light guide plate 30 in FIG. 7 in the light path direction (y-direction) is lgl. In FIG. 7, the horizontal straight lines marked on the emitting and incoming surfaces are fictitious lines to clearly depict the shape of the lens. The same applies to the following figures. The round prism 32 in FIG. 7 is an x-y cross-sectional view and the round prism 32 extends in the z-direction. In other words, it extends along the incident surface of the light guide plate 30. In FIG. 7, the magnitude of the apex angle φ of the round prism 32 is 75 degrees.

FIG. 8 depicts a cross-sectional view of the action of the round prism 32 at the incident surface. In FIG. 8, the arrows indicate the direction of the light emitted from the LED 10: light sl emitted from the LED that is directed in the y-direction and incident perpendicular to the flat surface 321 travels straight in the y-direction and becomes straight light sl; light sl emitted from the LED that is incident at right angles to the slope of the prism travels straight and becomes diffuse light dl. The light emitted from the LED 10 and incident at an angle with the slope of the prism 32 is refracted in the y-direction and becomes focused light cl.

By appropriately setting the shape of the round prism 32 and the area of the flat surface 321 on the incident surface of the light guide plate 30, the proportions of straight light sl, focused light cl and diffused light dl can be adjusted. Therefore, in combination with the action of the lenticular lens 31 on the output surface, the directivity of the light emitted from the light guide plate 30 can be controlled. In addition, light from a plurality of LEDs 10 can be sufficiently mixed in the light guide plate 30.

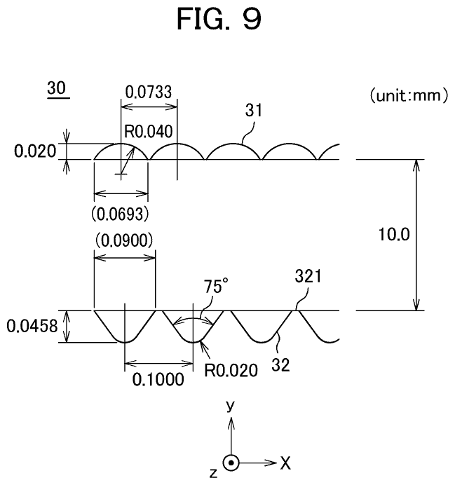

FIG. 9 depicts a cross-sectional view of the specific shapes of the incident and output surfaces of the light guide plate 30. On the incident surface side, the pitch of the round prisms 32 is 0.1 mm and the width is 0.09 mm, so that the width of the flat surface 321 is 0.01 mm. In order to produce some effect of the flat surface 321, it is desirable that 5% or 20% of the pitch of the round prisms 32 should be directed to the flat surface 321. The height of the round prism 32 is 0.0458 mm. The radius of curvature near the apex of the round prism is 0.02 mm. The cross-section of prisms formed in conventional light guide plates 30 are often sharply triangular, but in the present invention, the area near the apex of the prism is round. In other words, by making the area near the apex of the prism round, the balance between the focused light cl and the diffused light dl can be changed. In this example, the radius of curvature near the apex of the round prism 32 is, for example, 0.01 mm or more. If the radius of curvature is made too large, it becomes difficult to distinguish it from a lenticular lens, so that the radius of curvature should be kept below a range at which the triangular linear slope in the round prism can be maintained.

On the output surface side of the light guide plate 30 in FIG. 9, the pitch of the lenticular lenses 31 is 0.0733 mm and the width of the lenticular lens 31 is 0.0693 mm. The lens pitch is 0.004 mm larger than the lens width, but this is due to the requirements of the manufacturing method. The radius of curvature of the lenticular lens 31 is R 0.04 mm and the height is 0.02 mm.

As depicted in FIGS. 7 to 9, by using round prisms 32 at the incident surface of the light guide plate 30 and by forming a flat surface between the round prisms 32, light from each LED 10 can be sufficiently mixed in the light guide plate 30. In combination with the lenticular lens 31 on the exit surface, the directivity of the light emitted from the light guide plate 30 can be optimized.

In FIGS. 7 to 9, the direction of extension of the round prism 32 formed on the incident surface and the direction of extension of the lenticular lens 31 formed on the output surface are in the same z-direction. However, it is possible that the direction of extension of the round prism 31 formed on the incident surface and the direction of extension of the round prism 32 formed on the output surface may be at right angles.

### Embodiment 2

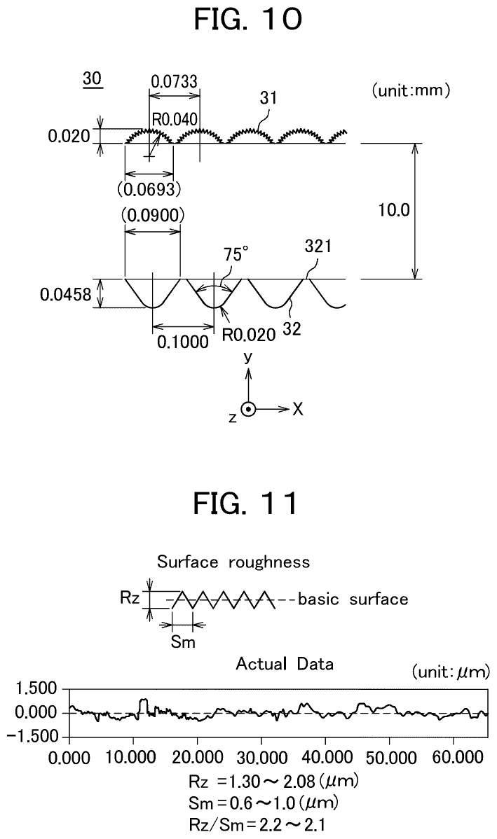

FIG. 10 is a cross-sectional view of the shape of the light guide plate 30 in Embodiment 2. The difference between FIG. 10 and FIG. 9 of Embodiment 1 is that in the light guide plate 30 of FIG. 10, the exit surface on which the lenticular lens 31 is formed is roughened. By roughening the exit surface, diffused light can be increased. This allows the light within the cover glass 400 to be homogenized.

On the other hand, in FIG. 10, the incident surface of the light guide plate 30 is not roughened. In other words, on the incident surface, light must be controlled by the ratio of the round prism 32 to the flat surface 321, and the radius of curvature near the apex in the round prism 32. This is because such a design can be more easily carried out if the surface is not roughened.

FIG. 11 depicts an example of a rough surface formed on the exit surface of the light guide plate 30. In other words, the figure defines Rz and Sm, which represent the degree of roughness. In this figure, triangular concavities and convexities in cross section are formed regularly, but this is merely for defining Rz and Sm. The actual rough surface has a series of irregular concavities and convexities.

The graph in FIG. 11 depicts an example of surface roughness on the emitting surface of an actual light guide plate 30. The units are μm. The values of Rz, Sm and Rz/Sm that can be read from the graph are Rz=1.30 to 2.08 μm, Sm=0.60 to 1.0 μm and Rz/Sm=2.2 to 2.1. To achieve a certain degree of roughening effect, for example, Rz should be, for example, 1.0 μm or more, Sm should be, for example, 0.5 μm or more and Rz/Sm should be 2 or more. On the other hand, the size of the rough surface should be kept to a level that does not affect the effect of the lenticular lens 31. Considering these conditions, Rz should be 1 μm or more and 5 μm or less, and Sm should be 0.5 μm or more and 4 μm or less.

By the way, when the light guide plate 30 is formed from acrylic or polycarbonate resin, injection molding is used, for example. If the mold used for injection molding is roughened, the surface of the light guide plate 30 can be roughened without any additional process.

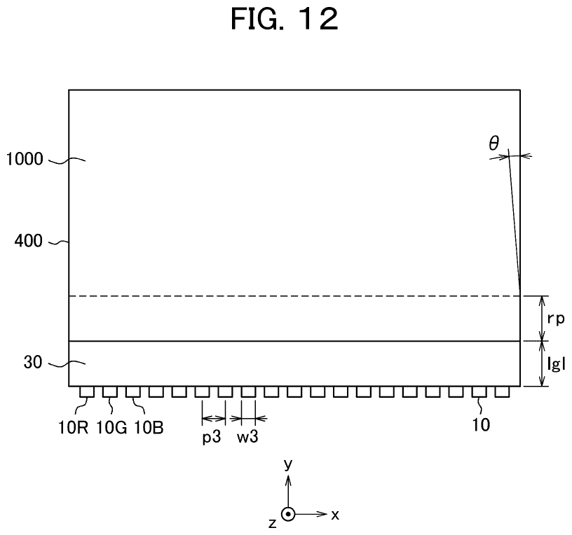

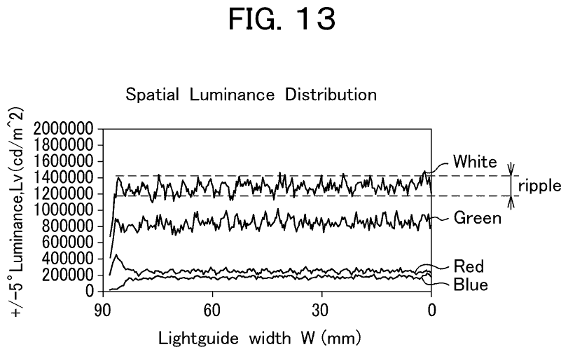

FIGS. 12 and 13 depict the results of evaluating the luminance distribution in the cover glass 400 when the light guide plate 30 depicted in FIG. 10 is used. The evaluation was carried out by computer simulation. FIG. 12 depicts a plan view of the transparent display device used as a premise in the simulation. The shape of FIG. 12 is the same as that in FIG. 5. In other words, a red LED 10R, a green LED 10G and a blue LED 10B are arranged on the incident surface of the light guide plate 30 with a pitch p3 (e.g. 3.66 mm). The size of each LED 10 is, for example, 2 mm in the x-direction.

On the incident surface of the light guide plate 30 depicted in FIG. 12, the round prism 32 is formed, and on the output surface of the light guide plate 30, the lenticular lens 31 with a roughened surface is formed, as depicted in FIG. 10. The length lgl in the y-direction of the light guide plate 30 is 10 mm. The dotted line in FIG. 12 is an imaginary line in the cover glass 400 depicting the part of the cover glass 400 where the luminance distribution was measured. The position of the dotted line is rp (14 mm) away in the y-direction from the emitting surface of the light guide plate 30 in the cover glass 400.

The angle θ to the edge of the light guide plate 30 extending in the y-axis direction (henceforth also simply referred to as angle θ to the y-axis direction) in FIG. 12 indicates the direction of light at the measurement position. At the measurement position in FIG. 12, the light taken into the liquid crystal display panel is light in the range of +5° to −5° in θ. Therefore, the integral value of the amount of light in the range of θ from +5 to −5 degrees was evaluated at the measurement position indicated by the dotted line in FIG. 12.

FIG. 13 depicts the evaluation results. The horizontal axis in FIG. 13 is the position, i.e. the position in the x-direction in FIG. 12, in mm. The vertical axis is the luminance Lv at each location, in cd/m². In other words, the vertical axis is the integral value of the quantity of light at each location in the range of θ from +5° to −5° as depicted in FIG. 12.

In FIG. 13, white (White), green (Green), red (Red) and blue (Blue) light is evaluated. The ripple of each color in FIG. 13 represents the variation in luminance. For example, the ripple for white is 15%. Generally, if the ripple is less than 20%, i.e. if the luminance fluctuation is less than 20%, the luminance fluctuation is considered to be acceptable.

For the single colors, Green, Red and Blue, the ripple is also approximately 15%, all of which are within the acceptable range. Therefore, the specifications in this example depicted in FIGS. 10 and 11 are specifications that counteract uneven luminance and uneven color.

As described above, by using the configuration of the present invention depicted in Embodiments 1 and 2, uneven luminance and uneven color in a transparent liquid crystal display device can be suppressed. In addition, the amount of light can be efficiently increased in the liquid crystal display panel.

The above description assumes that the cover glass 400 and the light guide plate 30 are arranged on the opposing substrate 200 side, but the same applies when they are arranged on the TFT substrate 100 side.

In the above description, the display device has been described as being a liquid crystal display device, but the invention is not limited to liquid crystal displays, and can also be applied to other transparent display devices that use side lights.

What is claimed is:

1. A liquid crystal display device having a liquid crystal being sandwiched between a thin-film transistor substrate including a pixel electrode and an opposing substrate,
wherein a display area is formed in a portion where the thin-film transistor substrate and the opposing substrate overlap, and a terminal area is formed in a portion of the thin-film transistor substrate that does not overlap with the opposing substrate,
a cover glass is arranged over the thin-film transistor substrate or the opposing substrate,
a first side surface of a light guide plate contacts the terminal area side of the cover glass,
a second side surface of the light guide plate, the second side surface being opposite to the first side surface of the light guide plate, is arranged with a plurality of light emitting diodes,
first lenses are formed on the first side surface of the light guide plate,
round prisms are formed on the second side surface of the light guide plate,
a pitch of the round prisms in a first direction is larger than a width in the first direction of a round prism.

2. The liquid crystal display device according to claim 1,
wherein the width in the first direction of the round prism is 80% to 95% of the pitch in the first direction of the round prisms.

3. The liquid crystal display device according to claim 1,
wherein a radius of curvature at an apex of the round prism is 0.01 mm or more, and a straight line exists at an oblique line in the round prism.

4. The liquid crystal display device according to claim 1,
wherein a flat plane exists between a first round prism and a second round prism.

5. The liquid crystal display device according to claim 1,
wherein the first lenses are lenticular lenses.

6. The liquid crystal display device according to claim 1,
wherein a pitch of the round prisms is larger than a pitch of the first lenses.

7. The liquid crystal display device according to in claim 1,
wherein an extending direction of the first lenses is same as an extending direction of the round prisms.

8. The liquid crystal display device according to claim 1,
wherein an extending direction of the first lenses is perpendicular to an extending direction of the round prisms.

9. The liquid crystal display device according to claim 1,
wherein a surface of a first lens is a rough surface.

10. The liquid crystal display device according to claim 1,
wherein Rz of the rough surface is 1.0 micrometer or more, and Sm of the rough surface is 0.5 micrometer or more.

11. The liquid crystal display device according to claim 1,
wherein Rz/Sm is 2 or more.

12. The liquid crystal display device according to claim 1,
wherein a surface of the round prism of the second side surface of the light guide plate is not roughened.

13. The liquid crystal display device according to claim 1,
wherein the cover glass is disposed on the opposing substrate.

14. The liquid crystal display device according to claim 1,
wherein a displayed image can be seen both from a side of the thin-film transistor substrate and from a side of the opposing substrate.
